(19) United States
(12) Patent Application Publication
(10) Pub. No.: US 2025/0027211 A1
(43) Pub. Date: Jan. 23, 2025

(54) High Ionic Strength Electrolyte for Improved Anion Exchange Membrane Water Electrolysis Performance

(71) Applicant: Paul A. Kohl, Atlanta, GA (US)

(72) Inventor: Paul A. Kohl, Atlanta, GA (US)

(21) Appl. No.: 18/778,631

(22) Filed: Jul. 19, 2024

Related U.S. Application Data
(60) Provisional application No. 63/514,615, filed on Jul. 20, 2023.

(51) Int. Cl. C25B 9/23; C25B 1/04

(52) U.S. Cl. CPC C25B 9/23; C25B 1/04

(57) ABSTRACT

An electrochemical electrolyzer device includes a cathode including a hydrogen evolution reaction (HER) catalyst and an anode spaced apart from the cathode, the anode including an oxygen evolution reaction (OER) catalyst. An anion exchange membrane (AEM) is disposed between the cathode and the anode. An anolyte having a hydroxide ion concentration is disposed against the anode and has a cation concentration that exceeds the hydroxide ion concentration in the anolyte. In a method of operating an electrochemical electrolyzer device that employs a cathode for producing hydrogen, an anode for producing oxygen and being spaced apart from the cathode, an anion exchange membrane (AEM) disposed between the cathode and the anode, an anolyte having a cation concentration that exceeds hydroxide ion concentration in the anolyte is placed against the anode.

### CROSS-REFERENCE TO RELATED APPLICATION(S)

This application claims the benefit of U.S. Provisional Patent Application Ser. No. 63/514,615, filed Jul. 20, 2023, the entirety of which is hereby incorporated herein by reference.

### STATEMENT OF GOVERNMENT SUPPORT

This invention was made with government support under grant number DE-EE0008833, awarded by the Department of Energy. The government has certain rights in the invention.

### BACKGROUND OF THE INVENTION

### 1. Field of the Invention

The present invention relates to anion-conducting polymer membrane electrochemical devices including electrolyzers. The invention also relates to the composition of the anolyte used in the electrolyzer. The electrochemical devices made in accordance with this invention include electrolyzers where the electro-inactive salts in the anolyte improve the electrolyzer performance by improving the hydrogen generating cathode performance.

### 2. Description of the Related Art

The production of renewable electricity can replace hydrocarbon-based electrical energy sources and provide global energy independence. Renewable energy is intermittent by nature and benefits from converting the electrical energy to a chemical form. The electrolysis of water provides a cost-effective way to produce and store chemical energy for use in chemical synthesis or transportation. Hydrogen can be produced on-site in a distributed manner by electrolysis of water from renewable energy including wind, solar and hydro sources, or from non-renewable electricity.

The electrolysis of water can be performed using a high pH, alkaline liquid electrolyte (ALE), proton exchange membrane (PEMEL), or anion exchange membrane (AEMEL) electrolysis device. The AEMEL offers advantages over both ALE and PEMEL. AEMEL devices can use low-platinum or no-platinum catalysts, as compared to PEMEL which use iridium and platinum catalysts. The solid polymer electrolyte can be operated at higher current density than an ALE liquid electrolyte and the membrane can support a pressure difference between the two electrodes allowing high-pressure hydrogen to be produced.

Compact AEMEL devices can be constructed by attaching the high surface area anode and cathode electrodes to the solid polymer membrane, sometimes called a zero-gap electrode. The high surface area electrodes allow (i) chemical reactants/products, (ii) ions, and (iii) electrons from the external circuit to reach the catalytic electrode sites where the electrochemical reactions occur. Three-dimensional electrodes are necessary because they enable a high surface area within a small, compact volume situated on the membrane.

The AEMEL combines the advantages ALE and PEMEL electrolyzers. The oxygen evolution reaction (OER) is more facile in AEMEL at high pH compared to low pH PEMEL electrolyzers. Also, AEMEL enables the use of non-platinum group metal (PGM) catalysts because it operates at high pH.

In alkaline electrolysis, hydroxide is oxidized at the positive electrode (i.e., anode) producing oxygen and water. Water is reduced at the negative electrode (i.e., cathode) producing hydrogen and hydroxide ions. Liquid water can be fed to the anode. The cathode can be operated without a liquid feed, sometimes called a “dry-cathode”, so that the hydrogen does not have to be separated from the liquid at the cathode. In the case of the dry-cathode, water is transported to the cathode from the anolyte by diffusion through the AEM. It is important to control the water uptake and ion exchange capacity (IEC) of the ion conducting polymers, sometimes called ionomers, used in the ink to make the cathode so that dry-out does not occur at the cathode because water is the cathode reactant. AEMEL performance improves when a hydrophilic ionomer is used in the cathode to retain water.

A high pH supporting electrolyte can be used in the water fed to the anode (i.e., anolyte) to improve electrolyte performance, as measured by lowering the required electrolysis voltage at a specific current density. The high pH anolyte improves cell performance because hydroxide is the reactant at the anode and a high concentration in the anolyte increases the anode reactant concentration. The hydroxide also improves the ion conductivity within the 3-D anode so that the anode catalyst particles deep within the anode are more effectively used without suffering a voltage drop from low ion conductivity anolyte.

However, the high pH of the anolyte is a durability concern because the ion conducting polymer used in the anode and the anion exchange membrane (AEM) can undergo nucleophilic attack by the hydroxide at high pH. In addition, operating the AEMEL without a liquid feed to the cathode can cause dry-out at the cathode because water delivery to the cathode is by diffusion from the anolyte through the AEM. The cathode current density cannot exceed the rate of water diffusion through the AEM. Thus, operating the cathode without a liquid feed can result in lower current density electrolysis due to inadequate water delivery from the anode to the cathode.

Therefore, there is a need for a system which can more effectively deliver water from the anolyte to the cathode through the AEM when the cell is operated in the absence of direct water feed to the cathode without increasing the pH of the anolyte. Excessively high anolyte pH can lead to long-term durability problems including polymer degradation and metal corrosion.

### SUMMARY OF THE INVENTION

The disadvantages of the prior art are overcome by the present invention which, in one aspect, is an electrochemical electrolyzer device that includes a cathode including a hydrogen evolution reaction (HER) catalyst and an anode spaced apart from the cathode, the anode including an oxygen evolution reaction (OER) catalyst. An anion exchange membrane (AEM) is disposed between the cathode and the anode. An anolyte having a hydroxide ion concentration is disposed against the anode and has a cation concentration that exceeds the hydroxide ion concentration in the anolyte.

In another aspect, the invention is an electrochemical electrolyzer that includes an anolyte having a cation concentration that exceeds a hydroxide ion concentration.

In yet another aspect, the invention is a method of operating an electrochemical electrolyzer device that employs a cathode for producing hydrogen, an anode for producing oxygen and being spaced apart from the cathode, an anion exchange membrane (AEM) disposed between the cathode and the anode, in which an anolyte having a cation concentration that exceeds hydroxide ion concentration in the anolyte is placed against the anode.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIGS. 1A-1C are electrolysis polarization curves using 0.01, 0.1, and 1.0 M NaOH anolytesz: (FIG. 1A) cell I-V curves, (FIG. 1B) three-electrode experiments: anode (three top) and cathode (three bottom) I-V curves and (FIG. 1C) Nyquist plots measured at 1 A/cm².

FIG. 2A-2G is the cell polarization (FIGS. 2A, 2E), three electrode polarizaton (FIGS. 2B, 2F) and impedance curves (FIGS. 2C, 2G) for 0.01 M NaOH anolyte with different NaNO₃ concentrations. FIG. 2D illustrates the performance within the electrode. The added NaNO₃ concentrations are 0.05 M, 0.1 M, and 0.15 (FIGS. 2A, 2B, 2C) and 0.25 M, 0.5 M, and 1.0 M (FIGS. 2E, 2F, 2G).

FIG. 3 is the steady-state electrolysis voltage-time profile for 0.01 M NaOH+0.15 M NaNO₃ co-salt electrolyte at 1 A/cm².

FIGS. 4A-4C are the electrolysis performance of 0.01 M NaOH with 0.15 M LiNO₃, NaNO₃, KNO₃, and CsNO₃: (FIG. 4A) 2-electrode cell polarization curves, FIG. 4B) 3-electrode polarization curves using a reference electrode, and (FIG. 4C) Nyquist plot measured at 1 A/cm².

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.” Where a numerical range is disclosed herein such range is continuous, inclusive of both the minimum and maximum values of the range as well as every value between such minimum and maximum values.

As used herein, the expression “dry-cathode” means a cathode operated with little or no direct liquid water feed. It is understood that the gaseous environment in the cathode chamber may be humid because water is transported through the AEM and water is the reactant at the dry-cathode.

The term “ion-conducting polymer” and “ion conductive ionomer” means a molecule with at least one monomer in the form R—XY. R is an organic moiety and —XY is an ionizable moiety. For example, in the case of an anion-conducting polymer, the ionizable moiety yields R—X+ and Y—. The cation X+ is immobile because it is chemically bonded to the polymer, R, and the anion Y— is a mobile anion because it is liberated or ionized from its counter ion. It is also understood that an ion-conducting ionomer or polymer may also be synthesized in the form R—Z, where the moiety —Z is converted into —XY in a post synthesis treatment. When the ion conductive polymer is used to form the electrode, the term ion conductive ionomer is often used.

Surprisingly, it has been found that the addition of pH-neutral, electro-inactive alkali salts to the anolyte significantly improves the cathode performance even though the anolyte solution is fed only to the anode and not the cathode. The present invention uses electro-inactive, Group 1 alkali salts in the anolyte to improve the cathode performance. The Group 1 alkali cations can be added to the anolyte without increasing the anolyte pH. The electrolyzer performance is improved due to the enhanced water delivery from the anode to the cathode via the AEM and durability is improved because the operating voltage with the pH neutral alkali salt is lower and the high pH induced degradation of the electrodes and AEM is lessened.

The poly(norbornene) AEMs used in one experimental embodiment of the present invention were composed of butyl norbornene (BuNB) and bromobutyl norbornene (BBNB) at a molar ration of 25:75. It is understood that other AEMs can be used in place of membranes used in the examples described here.

Poly(norbornene) terpolymer anion-conductive ionomers used to make the anode and cathode were composed of butyl norbornene (BuNB), bromobutyl norbornene (BBNB), and norbornene propionic acid ethyl ester (NBPEE). The NBPEE was used to form a pendant carboxylic acid by reaction with concentrated HCl. Bis-phenyl-A-diglycidyl ether (BPADGE) adhesive was added to the electrode ink to react with the carboxylic acid via an esterification reaction. The ratio of the three monomers in the ionomers (X:Y:Z) reflect their mole ratio (BuNB:BBNB:NBPEE). 50:30:20 ionomer was used in oxygen evolution reaction (OER) anode, and 4:90:6 ionomer was used in the hydrogen evolution reaction (HER) cathode. The IEC of 50:30:20 ionomer was 1.64 meq/g, and the IEC of 4:90:6 ionomer was 4.0 meq/g.

The OER and HER electrodes were fabricated using the solvent cast method with an airbrush (Eclipse HP-CS, Iwata) to spray-coat the catalyst ink onto each porous transport layer (PTL) as reported previously. The OER ink formulation used 11 mg of 50:30:20 ion conductive ionomer, dissolved in 5 ml of tetrahydrofuran (THF, Sigma Aldrich). 56 mg of BPADGE adhesive was dissolved in the solution. 46 mg of NiFe₂O₄ catalyst (Pajarito Powder) was added to the solution and sonicated in an ice bath for 1 hr. The slurry was sprayed onto 25 cm² of 680 μm thick Ni felt PTL (Technetics group), resulting in 0.5 mg/cm2, 0.12 mg/cm², and 0.6 mg/cm² of catalyst, ionomer, and adhesive. The HER electrode was prepared with the same fabrication method, except using 4:90:6 ionomer and Pt₃Ni HER catalyst (ECS-3701, Pajarito Powder). 1.2 mg/cm², 0.6 mg/cm², and 0.1 mg/cm² of catalyst, ionomer, and adhesive were spray-coated onto 14.63 cm² of 250 μm thick non-wet proofed carbon paper PTL. The anodes and cathodes were cured at 160° C. under vacuum for 1 hr to complete the esterification reaction between BPADGE and NBPEE carboxylic acid. The electrodes were aminated by soaking in aqueous trimethyl amine (TMA) solution for 24 hr at room temperature.

The membrane electrode assembly (MEA) used 4 cm² anode and cathode. The anion exchange membrane (AEM) was 40 μm thick GT75-5 (Xergy Inc.). GT75-5 was made with 25:75:0 polynorbornene ion conductive polymer (described above) with 5 mol % N,N,N,N-tetramethyl hexadiamine crosslinker. The mole percent crosslinker was with respect to the available bromobutyl sites. The anode, cathode, and AEM were ion-exchanged in 0.1 M NaOH under N₂ atmosphere for 1 hr prior to use. The AEM was placed between the anode and cathode. A 250 am thick Pt wire (Alfa Aesar) in contact with the cathode side of the AEM was used as a pseudo reference electrode (pRE). The wire was placed on top of the AEM next to the cathode, maintaining 2 mm distance from the cathode electrode. The pRE was exposed to the hydrogen gas during electrolysis, however, the exact partial pressure of hydrogen gas and pH of the AEM varied slightly from run-to-run making it only a pseudo-reference electrode. Tefzel gaskets were used for the integration of pRE into the MEA. The MEAs were pressed between a pair of serpentine flow-patterned stainless-steel blocks with 25 in-lb of torque in the cell hardware.

The electrolysis cells were tested using a custom test station, operated at 60° C. The aqueous electrolyte was recirculated through the anode flow-field with a dry cathode at 17.9 mL/min flow rate using a peristaltic pump (YT25, Golander). The cell was conditioned at 0.1 A/cm² for 40 min using a DC power supply (N5742A, Keysight). The applied current was then gradually increased to 1 A/cm². The beginning-of-life (BOL) impedance spectra were recorded galvanostatically at 1 A/cm² using SP-300 (BioLogic) after 1 A/cm² operation for 5 min to develop steady-state mass transport of reactants and products within the cell. The end-of-life (EOL) impedance spectra were recorded at 1 A/cm². The data points for the polarization curves were recorded by stepping the current from zero to 1 A/cm² in 0.0125 A/cm² steps and holding for 3 min before recording the voltage.

The sodium ion concentration in the AEM was determined by inductively coupled plasma mass spectroscopy (ICP-MS) analysis. Three AEM samples were dried in an oven at 80° C. under vacuum overnight to determine the dry weight (w_{AEM, dried}). The AEM samples were soaked in (i) DI water, (ii) 0.01 M NaOH, and (iii) 0.01 M+1.0 M NaNO₃. The samples were removed from the solutions and the excess liquid was wiped from the surface and the AEM mass was obtained (w_{AEM,soaked}). The AEMs were immersed in a known mass of DI water (w_{DIW,added}) and soaked overnight to extract the sodium salt from the membranes. The sodium ion concentration in these three liquid samples (Table 1: Samples #1, #2, and #3) was obtained by ICP-MS. A portion of an AEM used for 40 hr electrolysis at 1 A/cm² using 0.01 M NaOH anolyte was immersed in a known amount of DI water and its concentration was obtained (Table 1: Sample #4) by ICP-MS. The mass of sodium ions in the analyzed water was converted to equivalents/gAEM, Table 1.

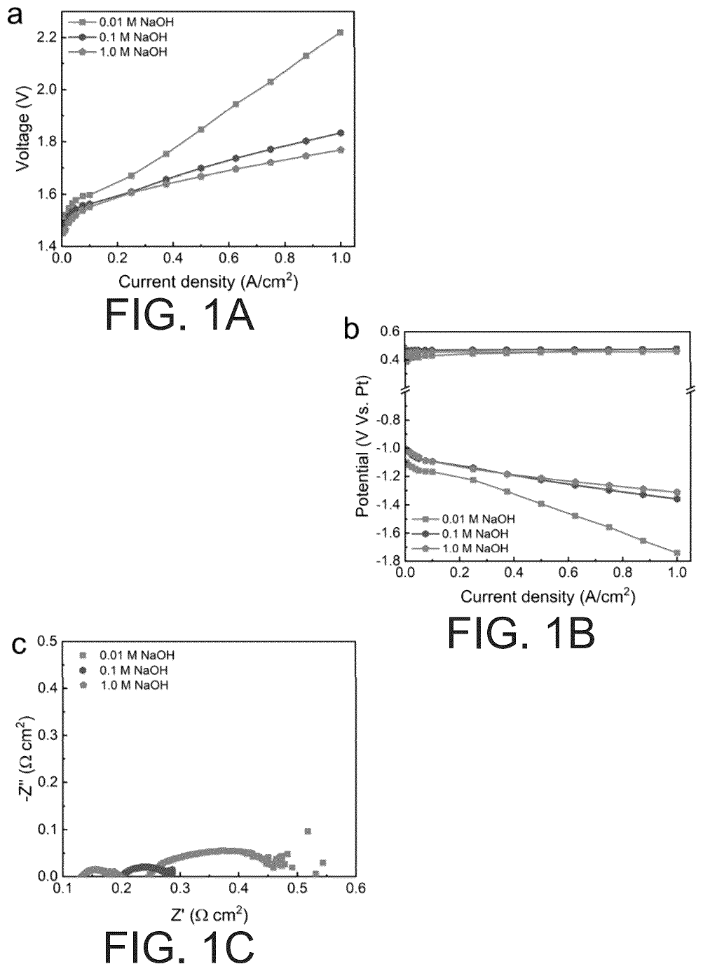

The electrolysis voltage vs current density for three anolyte concentrations, 0.01 M, 0.1 M, and 1.0 M NaOH is shown in FIG. 1A. It has been reported that the electrolysis voltage decreases (improves) with higher NaOH concentration because the ionic conductivity within the three-dimensional (3-D) anode increases enabling better catalyst utilization and the higher NaOH concentration improves the OER kinetics. The higher ionic conductivity in the 3-D anolyte lowers the anode resistance and overpotential, thus improving the electrolysis voltage. The I-V curves, as shown in FIG. 1A, show an electrolysis voltage (1.75 V, 1.8 V, and 2.2 V) at 1 A/cm² for the 1.0 M, 0.1 M, and 0.01 M NaOH anolyte, respectively.

A pRE was integrated into the electrolysis cell to investigate the current-voltage behavior at each electrode independently. The reference electrode consisted of a platinum wire in contact with the AEM on the hydrogen side of the membrane in a region where it was exposed to hydrogen gas being produced by the cathode, but not in electrical contact with the cathode itself. Also, the relative humidity of the hydrogen gas (hydrogen gas partial pressure) was not controlled. Thus, the potential of the pseudo-reference may be slightly different from cell-to-cell. The potential of the anode and cathode (vs. pRE) in FIG. 1A are shown in FIG. 1B, in which the upper three curves show the anode potential vs current density, and the bottom three curves show the cathode potential vs current density for the three anolyte concentrations (0.01 M, 0.1 M, and 1.0 M NaOH). The absolute value of the pRE is slightly more negative for the 0.01 M NaOH electrolyte. This experiment was repeated with many cells and the trends were the same.

There are several striking features in FIG. 1B. First, the anode voltage (upper three curves at ca. 0.4 V) for each of the three anolytes are nearly constant as the current was increased. This means that there is little series resistance within the water-fed anode or kinetic overpotential. The slope of the I-V curve is slightly greater (i.e., higher overpotential) for the 0.01 M NaOH anode electrolyte. This means that the higher concentration supporting electrolytes in FIGS. 1A-1C only slightly improve the anode conductivity and kinetics as the NaOH concentration was increased from 0.01 M to 1.0 M. The anode activation overpotential (slope at low current) slightly improved as the NaOH concentration was increased.

The second notable feature of FIG. 1B is that the slope of the cathode I-V curve has a greater magnitude than the slope of the anode I-V curve. The higher ohmic and mass transport losses at the cathode, compared to the anode, is due to the dry-cathode operation. Ionic conductivity and mass transport at the cathode are supplied only by the cathode ionomer because there is no liquid water supplied. Water is consumed at the cathode and supplied by diffusion from the anode through the AEM.

Third, it is surprising that the anolyte concentration affected the conductivity and mass transport of both electrodes (especially the cathode), not just the anode. The anolyte concentration has a more dramatic effect on the cathode overpotential and mass transport than the anode, as shown by the dramatic change in cathode slope when going from 0.01 M NaOH to 0.1 M NaOH anolyte. Clearly, the intra-cathode ionic conductivity and mass transport, which come only from its thin ionomer layer, improved with anolyte NaOH concentration. It is not clear from FIGS. 1A and 1B why the anolyte concentration affects the cathode ohmic or mass transport loss and why the cathode changes are greater than the anode changes with anolyte concentration. The IEC of the AEM and cathode ionomer were the same in each experiment and at every current density. This change in the cathode overpotential with anolyte pH raises the fundamental question as to how the anolyte NaOH concentration changes the overpotential at the dry-cathode.

To further investigate the change in overpotential, the electrochemical impedance spectra (EIS) for the three cells in FIG. 1A were obtained, FIG. 1C. The EIS frequency is highest on left side and lowest on the right side of each spectrum. The series resistance, as given by the x-intercept through extrapolation at high frequency (i.e., high frequency resistance (HFR) on the left side of the spectrum), shows that the cell HFR decreased from 0.25 ohm cm² to 0.20 ohm cm² and 0.13 ohm cm² when the NaOH concentration increased from 0.01 M NaOH to 0.1 M and 1.0 M NaOH, respectively. The slope of I-V curve of 0.01 M NaOH (˜0.75 ohm cm²) is much greater than HFR (0.25 ohm cm²). This suggests that the cathode mass transport limitation in FIG. 1B was the major cause of the overall overpotential at high current density. An EIS loop was observed for each cell, which represents the combined parallel resistance-capacitance elements for the two electrodes. This complex impedance includes the charge transfer and double layer impedances coupled with mass transport impedance at both electrodes. The magnitude of this combined anode/cathode impedance is the difference between the HFR and low frequency resistance (LFR) (i.e., x-intercept extrapolated as the frequency decreased on the right side of the spectrum). The difference between the HFR and LFR was smallest when the anolyte concentration was highest indicating that the charge transfer and mass transport impedance is lowest for the 1.0 M anolyte.

The cause of the cathode overpotential change in FIGS. 1A-1C with increasing anolyte concentration was investigated. It is not clear why raising the hydroxide concentration in the anolyte (or anywhere in the cell) would improve the dry-cathode overpotential because hydroxide is produced at the cathode and migrates through the AEM to the anode where it is consumed during oxidation at the anode. Increasing the hydroxide concentration in the AEM or cathode should have a negative effect, if any.

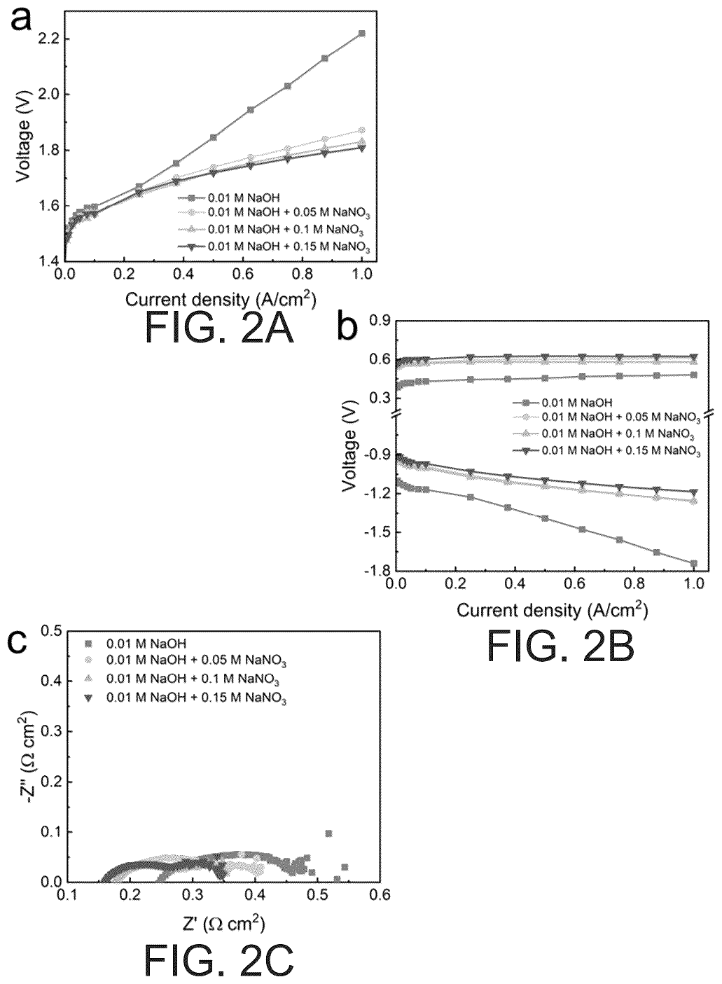

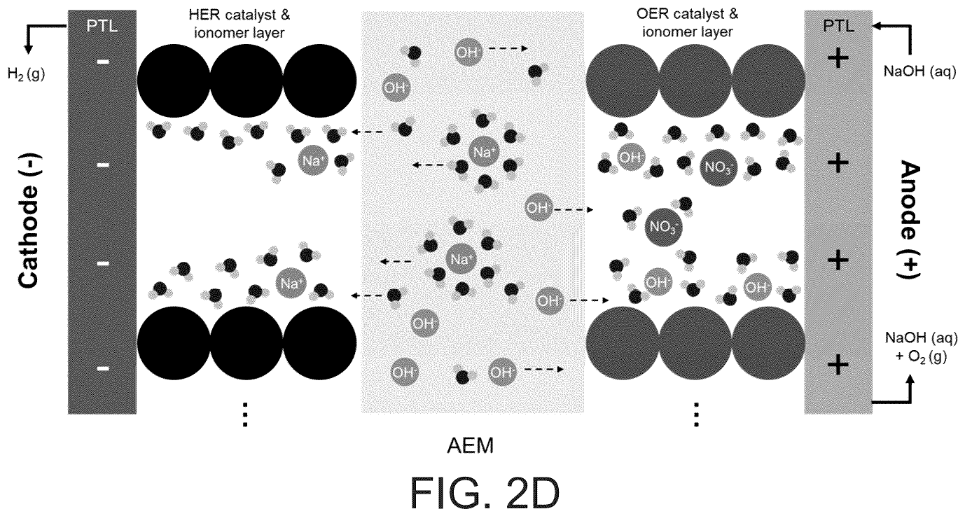

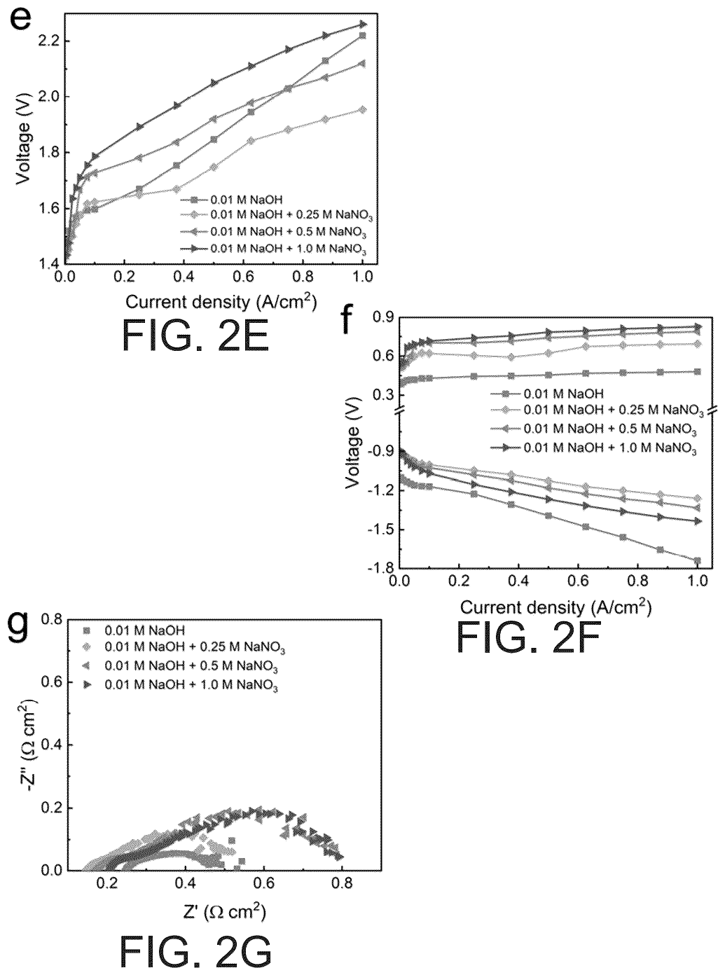

To differentiate between the effect of hydroxide and sodium ion concentration in the anolyte on the cell performance, seven anolyte feeds were used. FIGS. 2A and 2E show the overall cell I-V curves for cells with identical hydroxide concentration (0.01 M NaOH) and different sodium ion concentrations by adding inert NaNO₃ to the 0.01 M NaOH anolyte. The electrolysis voltage with 0.01 M NaOH (squares) is shown in FIG. 2A, 0.01 M NaOH+0.05 M NaNO₃ (circles), 0.01 M NaOH+0.1 M NaNO₃ (upward triangles), and 0.01 M NaOH+0.15 M NaNO₃ (downward triangles). The addition of even 0.05 NaNO₃ to the anolyte significantly improved the electrolysis voltage compared to the 0.01 M NaOH (only) anolyte, especially at higher current where mass transfer effects occur. The overpotential (i.e., activation, ohmic, and mass transport) dramatically improved with the addition of just 0.05 M NaNO₃ to the anolyte with the largest impact occurring at the cathode, FIG. 2B. Increased NaNO₃ concentration from 0.05 M to 0.15 M (same pH) had a small but measurable improvement. Surprisingly, the addition of 0.15 M NaNO₃ addition to 0.01 M NaOH (pH 12) produced better performance (1.81 V at 1 A/cm²) compared to 0.1 M NaOH (pH 13) (1.834 V at 1 A/cm²) in FIGS. 1A-1C. These results show that the sodium ion concentration within the anolyte is responsible for the cathode improvement because the hydroxide concentration was unchanged in FIGS. 2A-2G.

Inclusion of the pRE allows examination of the overpotential at each electrode as a function of current density. FIG. 2B shows that the anode I-V slope for the 0.01 M NaOH (squares) is only slightly greater than the anode I-V slope for each of the other three curves (0.01 M NaOH+0.05 M to 0.15 M NaNO₃). It is noted that the pRE potential was slightly different (more negative) in the three cells with NaNO₃. The 0.01 M NaOH cathode I-V curve (squares) has a significantly greater magnitude slope than with the three NaNO₃ containing anolytes, similar to the trend in FIG. 1B where the sodium ion concentration was increased by adding NaOH (not NaNO₃).

It is noted that there was a slight increase in anode activation overpotential (i.e., low current density (<0.1 A/cm²) region of FIG. 2B). This is likely due to the decrease in anode performance with added NaNO₃ because nitrate at the anode surface is electro-inactive. Thus, the improvement in polarization with NaNO₃ (FIG. 2A) is due to the improved cathode HER, with little deterioration of the anode OER.

The Nyquist plots in FIG. 2C show a decrease in HFR and interfacial impedance of charge transfer and mass transport (i.e. difference between HRF and LFR) as the NaNO₃ concentration increased. HFR decreased due to the improved ionic conductivity within the anolyte with NaNO₃ addition. The HFR of 0.1 M NaOH (FIG. 1C) is close to the HRF of 0.01 M NaOH+0.1 M M NaNO₃ (FIG. 2C). As the NaNO₃ concentration increased, the total interfacial impedance (difference between HFR and LFR) decreased, however, the decrease was not as great as in FIG. 1C. For example, the charge transfer impedance for 0.1 M NaOH was less than the charge transfer impedance for 0.01 M NaOH+0.1 M NaNO₃ because only the cathode impedance improved with NaNO₃ addition (FIG. 2B) because the anode pH was unchanged with NaNO₃ addition. Thus, the results shown in FIGS. 2A and 2B show that the cathode improvement was due to the higher sodium ion concentration in the anolyte, rather than the hydroxide concentration in the anolyte (or in the membrane), because the hydroxide concentration was unchanged in FIG. 2B but the improvement was still observed.

It is known that AEMs do not have perfect salt rejection and a small amount of salt from the electrolyte can be taken up in the membrane. Sodium ions present in the membrane migrate to the hydrogen cathode during electrolysis, while carrying multiple waters of hydration (FIG. 2D). The sodium ions continue to build up at the cathode until their concentration gradient was sufficiently high to cause the back diffusion of sodium ions from the cathode to anode at a flux matching the migration to the cathode. A steady-state gradient in sodium ions is created as the migration to the cathode is balanced by the diffusion away from the cathode.

It is also known that the addition of salts to the poly(norbornene) AEM plasticizes the membrane and increases ion diffusivity. This water delivery mechanism swells and hydrates the AEM and cathode. Water is the reactant at the cathode. Thus, in the case where the sodium ion concentration was increased by adding NaOH (FIGS. 1A-1C), both the anode and cathode would improve. The cathode improved due to the water delivery mechanism (i.e., greater overall flux of water to the cathode). In the case where the only the sodium ion concentration increased due to the addition of NaNO₃ to 0.01 M NaOH (FIGS. 2A-2G), then only the cathode performance would improve because the anolyte pH did not increase and nitrate has no benefit on the anode's performance. Thus, the use of added NaNO₃ in the anolyte (rather than added KOH), the cathode benefits were realized without suffering the polymer degradation and metal corrosion problems at higher pH.

The concentration of sodium ions in the membrane was measured by ICP-MS to show that sodium ions are available for diffusion and migration through the membrane. Table 1 shows the concentration of sodium ions in AEM under different conditions. An AEM soaked in 0.01 M NaOH did not show a detectable sodium content. The AEM has high salt rejection when the salt concentration in the liquid phase is low (i.e., 0.01 M NaOH). When the NaNO₃ concentration approached that in the AEM (third row of Table 1: 0.01 M NaOH+1.0 M NaNO₃), sodium ions were found in the membrane. The DI water used to soak the membrane contained 26 ppm sodium which corresponds to 0.147 meq/g of sodium ions in the AEM, assuming all the sodium ions were extracted during the DI water soak. The IEC of the AEM was 3.58 meq/g. Thus, for every 100 quaternary ammonium cations tethered to the polymer backbone in the AEM, there are about 4 sodium ions when the AEM was soaked in 1.0 M NaNO₃. This shows that the membrane does take-up a small amount of sodium ions. The AEM after electrolysis with 0.1 M NaOH anolyte for 40 hr had 0.08 meq/g of sodium ions. It is noted that during electrolysis, the sodium ions migrate to the cathode which would increase their concentration in the AEM. These findings provide clear evidence that the sodium ions are in the AEM during electrolysis and can travel through the AEM by diffusion and migration. Although sodium ions are electro-inactive at the cathode, they can drag water in their hydration shell toward the cathode, and the sodium ions plasticize the AEM increasing the diffusivity and mobility of all ions. These factors serve to lower the cathode overpotential (FIG. 2D).

TABLE 1
ICP-MS analysis of Na+ concentration
and IEC in AEMs and cathode.

| | | | Na+ | |
|---|---|---|---|---|
| | Material | Solution | concentration | IECNa+ |
| | tested | tested | (ppm) | (meq/g) |
| Ex-situ test | AEM | DI water | 0 | 0 |
| | AEM | 0.01M NaOH | 0 | 0 |
| | AEM | 0.01M NaOH + | 26 | 0.147 |
| | | 1.0M NaNO₃ | | |
| Electrolysis | AEM | 0.1M NaOH | 19 | 0.080 |
| for 40 hrs at | | | | |
| 1 A/cm2 | | | | |

The effect of higher concentrations of NaNO₃ in the anolyte was investigated by increasing the NaNO₃ molarity in 0.01 M NaOH to 0.25 M, 0.5 M, and 1.0 M, FIGS. 2E-2F, and 2g. Although the addition of 0.25 M NaNO₃ to 0.01 M NaOH improved the polarization voltage (1.954 V at 1 A/cm²) compared to 0.01 M NaOH (2.22 V at 1 A/cm²) due to the sodium ion cathode enhancement, the anode activation overpotential became more significant as shown in FIGS. 2E-2F. The addition of 0.5 M and 1.0 M NaNO₃ showed more deterioration in the anodic activation overpotential. This negative effect on the anode is due to the increased nitrate concentration in the anolyte and anode ionomer. When the anolyte contained 1.0 M NaNO₃+0.01 M NaOH, the anode ionomer contained predominantly nitrate anions which although they would be conductive, they would be electro-inactive at the anode catalyst. FIG. 2G shows that the high nitrate concentration replaced the hydroxide (which is the anode reactant) in the OER ionomer. The anodic interfacial impedance increased, while change in the cathodic interfacial impedance was relatively small. The interfacial impedance with 1.0 M NaNO₃+0.01 M NaOH was significantly higher than with 1.0 M NaOH in FIG. 1C.

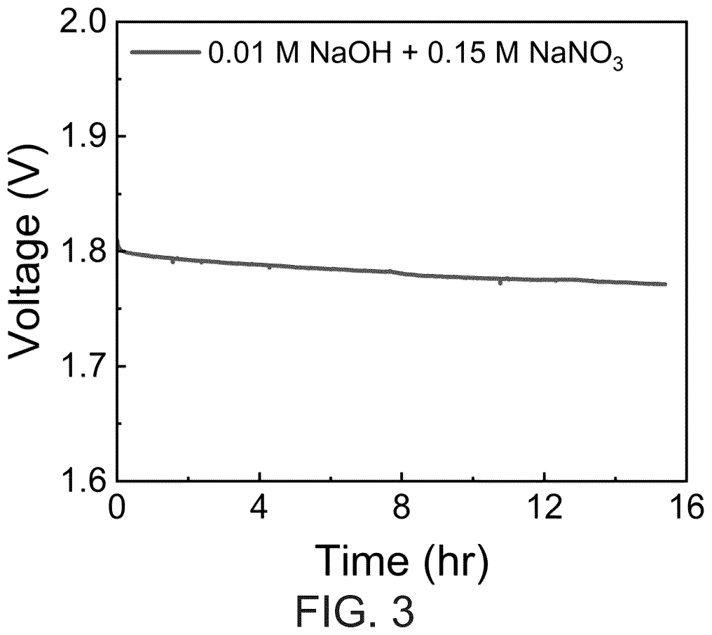

A steady-state voltage-time profile with 0.01 M NaOH+0.15 M NaNO₃ anolyte at 1 A/cm² is shown in FIG. 3. This shows a stable, slightly decreasing voltage profile likely due to an improvement in HFR and interfacial impedance. The electrolysis voltage after 15 hr was 1.77 V. Higher NaNO₃ concentration (0.5 M NaNO₃+0.01 M NaOH) did not provide a stable steady-state voltage profile due to the OER ionomer ion exchanging with electro-inactive nitrate. Thus, the optimal electro-inactive salt (i.e., NaNO₃) concentration can improve the transient electrolysis performance (e.g., FIG. 2A-2C) while improving the overall cell durability because lower pH anolytes can be used.

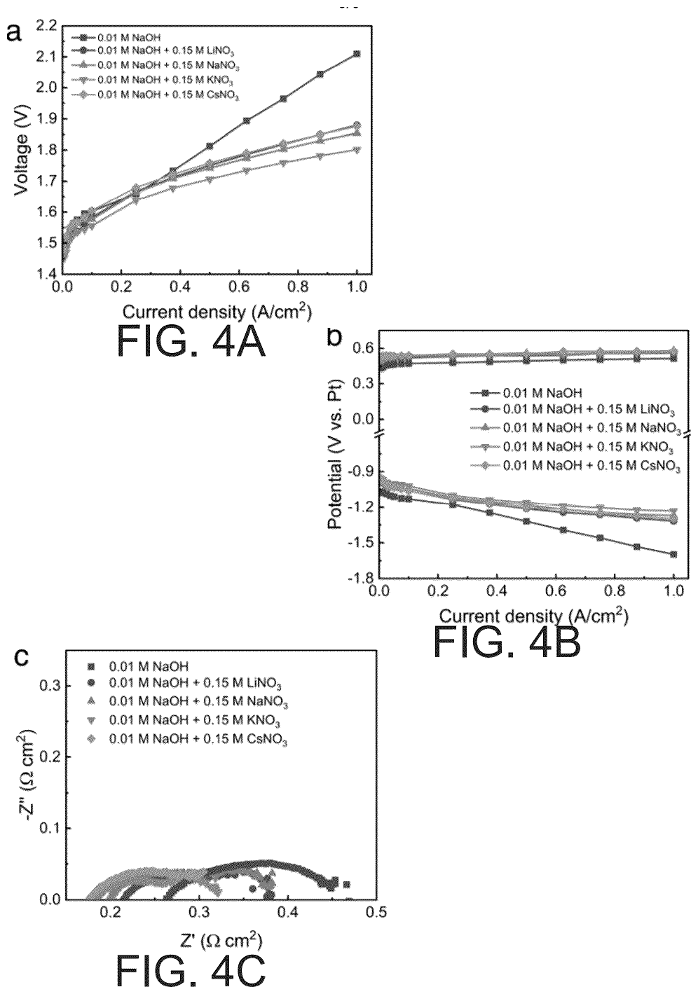

The beneficial effect of different alkali cations in the anolyte was demonstrated. FIGS. 4A-4C shows the effect of Li⁺, Na⁺, K⁺, and Cs⁺ in the anolyte on the electrolysis overpotential. The cathode overpotential decreased with the addition of each alkali cation, compared to anolyte containing only 0.01 M NaOH, as shown in FIG. 4A. At high current density, K⁺ was the highest performing alkali cation and Li⁺ was the lowest. The order of performance is as follows: K⁺>Na⁺>Cs⁺>Li⁺. In FIG. 4A, there is a small change in the activation overpotential at low current density (i.e., <0.1 A/cm²). This shows that the overpotential with K⁺ was also the lowest at low current density (<0.1 A/cm²). The overpotential with K⁺ was also the lowest at high current density (1 A/cm²), compared to other cations tested, FIG. 4A. The overpotential at high current density includes the effect of ohmic and mass transport resistances.

The anode potential (top four curves) and cathode potential (bottom four curves) vs. pRE as a function of current density is shown in FIG. 4B. The potential difference between the anode and cathode in FIG. 4B corresponds to the full cell potential in FIG. 4A. The anode potential remained nearly constant vs. current density for each anolyte because the pH in each electrolyte was the same.

The Nyquist plots for the different anolytes is shown in FIG. 4C. The extracted impedance values are summarized in Table 1. A single out-of-phase component (near semi-circle interfacial impedance) was observed for the 0.01 M NaOH anolyte. The difference between the low frequency x-intercept and high-frequency x-intercept is defined here as the interfacial impedance. When the salt was added to the 0.01 NaOH electrolyte, the out-of-phase component is broken into two contributions composed of a cathode (higher frequency loop) and an anode (lower frequency loop) interfacial impedance. The ohmic series resistance, HFR, decreased with added anolyte salt due to the improved ionic conductivity. The HFR for the five anolytes were in the following order (smaller is better): Cs⁺<K⁺<Na⁺<Li⁺<none. The bulkier cations have a smaller water solvation shell and weaker interaction with water which leads to higher ionic mobility and water diffusivity. Notably, the anolyte with K⁺ showed the lowest overall cell voltage.

The interfacial resistance (Rᵢₙₜ) decreased (i.e., smaller is better) in a slightly different sequence than the HFR: K⁺<Li⁺<Cs⁺<Na⁺<none. Rᵢₙₜ consists of the charge transfer and mass transfer resistances. The interfacial capacitance (Cᵢₙₜ) is related to the total effective catalyst surface area (i.e., bigger is usually better): none<Cs⁺<Na⁺<Li⁺<K⁺. A greater water flux delivered by the cation in the AEM via migration increases the effective electroactive surface area of the catalyst. This leads to a decrease in the charge and mass transfer resistance at the 3-D cathode because the catalyst is more effectively used. The trend of Rᵢₙₜ and Cᵢₙₜ shows that the cation and water mass transfer improvement and HER electroactive surface area are improved with addition of a more mobile anolyte cation.

TABLE 2
Impedance analysis of 0.01M NaOH and high ionic strength
electrolytes with 0.15M of LiNO₃, NaNO₃, KNO₃, and CsNO₃.

| | | | | Eₒᵥₑᵣₐₗₗ @ |
|---|---|---|---|---|
| | HFR | Rᵢₙₜ | Cᵢₙₜ | 1 A/cm² |
| | (Ω cm²) | (Ω cm²) | (F/cm²) | (V) |
| 0.01M NaOH | 0.263 | 0.205 | 0.011 | 2.11 |
| 0.01M NaOH + | 0.215 | 0.165 | 0.061 | 1.88 |
| 0.15M LiNO₃ | | | | |
| 0.01M NaOH + | 0.198 | 0.182 | 0.055 | 1.854 |
| 0.15M NaNO₃ | | | | |
| 0.01M NaOH + | 0.186 | 0.136 | 0.066 | 1.802 |
| 0.15M KNO₃ | | | | |
| 0.01M NaOH + | 0.177 | 0.173 | 0.033 | 1.876 |
| 0.15M CsNO₃ | | | | |

The presence of the alkali cation in the AEM, and relative importance of the different alkali cations was further demonstrated by measuring the transference number for each alkali cation in the anolyte at 0.01 M. The transference number for a particular ion is the fraction of the total ionic charge which is carried by that ion in the absence of a concentration gradient. The sum of all the transference numbers is equal to one. The poly(norbornene) AEMs have a tethered quaternary ammonium cation which makes the quaternary ammonium cation immobile in the AEM. The polymer chains in the AEM are bulky with a molecular weight of about 60,000 g/mole and the polymer chains are also 5% crosslinked making the whole membrane a thermoset polymer.

Table 3 shows the transference number for the hydroxide anion and alkali cation in 0.01 M and 0.1 M hydroxide electrolytes. When the anolyte concentration was 0.01 M, the cation transference number was 0.13 to 0.16. When the anolyte concentration was increased to 0.1 M, the cation transference number increased to 0.20 to 0.23. The higher concentration of alkali ion in the anolyte increased the alkali cation concentration in the AEM leading to a higher cation transference number because the ratio of mobile alkali cations to immobilized quaternary ammonium cations tethered to the polymer increased as the anolyte concentration increased. Cs⁺ shows the highest cation transference number, however, the electrolysis voltage (i.e., cathode overpotential) of the cell with Cs⁺ was not the lowest. This result shows that water transport is not only related to the cation mobility, but is also affected by the cation hydration number. Cations with a higher hydration number, such as potassium, can deliver more water per ion which improves the cathode performance because water is the reactant at the cathode.

TABLE 3
Cation transference number calculated with alkaline water electrolysis
by modified Bruce-Vincent method. 1.5 V was applied to cells.

| Concentration | Electrolyte | t_{OH-} | t_{M+} |
|---|---|---|---|
| 0.01M | LiOH | 0.869 | 0.131 |
| | NaOH | 0.855 | 0.145 |
| | KOH | 0.840 | 0.160 |
| | CsOH | 0.827 | 0.173 |
| 0.1M | LiOH | 0.799 | 0.201 |
| | NaOH | 0.786 | 0.214 |
| | KOH | 0.779 | 0.221 |
| | CsOH | 0.770 | 0.230 |

The benefits to the AEMEL device by the addition of pH-neutral anolyte salts, rather than hydroxide containing alkali salts, have been described. It has been discovered that the addition of hydroxide or pH-neutral alkali salt has a dramatic effect on the cathode performance, even though the ion-containing electrolyte is only in contact with the anode. The benefits of using a pH-neutral salt are not limited by the particular examples described here.

Although specific advantages have been enumerated above, various embodiments may include some, none, or all of the enumerated advantages. Other technical advantages may become readily apparent to one of ordinary skill in the art after review of the figures and description. It is understood that, although exemplary embodiments are illustrated in the figures and described herein, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above-described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. An electrochemical electrolyzer device, comprising:
(a) a cathode including a hydrogen evolution reaction (HER) catalyst;
(b) an anode spaced apart from the cathode, the anode including an oxygen evolution reaction (OER) catalyst;
(c) an anion exchange membrane (AEM) disposed between the cathode and the anode; and
(d) an anolyte having a hydroxide ion concentration and being disposed against the anode having a cation concentration that exceeds the hydroxide ion concentration in the anolyte.

2. The electrochemical electrolyzer device of claim 1, further comprising:
(a) a first porous transport layer disposed between the cathode and the AEM, the oxygen evolution reaction (OER) catalyst disposed on the first porous transport layer; and
(b) a second porous transport layer disposed between the he AEM and the anode, the hydrogen evolution reaction (HER) catalyst disposed on the second porous transport layer.

3. The electrochemical electrolyzer device of claim 1, wherein the anolyte comprises:
(a) water;
(b) a salt consisting of a group I cation and a hydroxide ion; and
(c) a salt of the group I cation and a nitrate ion.

4. The electrochemical electrolyzer device of claim 3, wherein the group I cation comprises sodium.

5. The electrochemical electrolyzer device of claim 3, wherein the group I cation comprises potassium.

6. The electrochemical electrolyzer device of claim 5, having a potassium ion concentration that is between 0.01 M and 1.0 M.

7. The electrochemical electrolyzer device of claim 1, wherein the anolyte comprises a high ionic strength anolyte.

8. An electrochemical electrolyzer that includes an anolyte having a cation concentration that exceeds a hydroxide ion concentration.

9. The electrochemical electrolyzer of claim 8, further comprising:
(a) a cathode including a hydrogen evolution reaction (HER) catalyst;
(b) an anode spaced apart from the cathode, the anode including an oxygen evolution reaction (OER) catalyst; and
(c) an anion exchange membrane (AEM) disposed between the cathode and the anode.

10. The electrochemical electrolyzer of claim 8 wherein the anolyte comprises:
(a) water;
(b) a salt consisting of a group I cation and a hydroxide ion; and
(c) a salt of the group I cation and a nitrate ion.

11. The electrochemical electrolyzer of claim 10, wherein the group I cation comprises sodium.

12. The electrochemical electrolyzer of claim 10, wherein the group I cation comprises potassium having a potassium ion concentration that is between 0.01 M and 1.0 M.

13. A method of operating an electrochemical electrolyzer device that employs a cathode for producing hydrogen, an anode for producing oxygen and being spaced apart from the cathode, an anion exchange membrane (AEM) disposed between the cathode and the anode, the method comprising the step of placing an anolyte having a cation concentration that exceeds hydroxide ion concentration in the anolyte against the anode.

14. The method of claim 13, further comprising the steps of:
(a) placing a first porous transport layer between the cathode and the AEM; and
(b) placing a second porous transport layer disposed between the he AEM and the anode.

15. The method of claim 14, further comprising the steps of:
(a) disposing the oxygen evolution reaction (OER) catalyst on the first porous transport layer; and
(b) disposing the hydrogen evolution reaction (HER) catalyst on the second porous transport layer.

16. The method of claim 13, wherein the anolyte comprises:
(a) water;
(b) a salt consisting of a group I cation and a hydroxide ion; and
(c) a salt of the group I cation and a nitrate ion.

17. The method of claim 16, wherein the group I cation comprises sodium.

18. The method of claim 16, wherein the group I cation comprises potassium.

19. The method of claim 18, having a potassium ion concentration that is between 0.01 M and 1.0 M.

20. The method of claim 13, wherein the anolyte comprises a high ionic strength anolyte.
